(19) United States
(12) Patent Application Publication
(10) Pub. No.: US 2017/0183818 A1
(43) Pub. Date: Jun. 29, 2017

(54) A METHOD OF FEEDING A SEALING MEDIUM INTO A LIQUOR FILTER AND A LIQUOR FILTER

(71) Applicant: Andritz Oy, Helsinki (FI)

(72) Inventors: Tommi HAMMARBERG, Joutseno (FI); Mika KOTTILA, Klaukkala (FI); Matti MANTSINEN, Kotka (FI); Simo SUUTARI, Summa (FI)

(73) Assignee: Andritz Oy, Helsinki (FI)

(21) Appl. No.: 15/129,782

(22) PCT Filed: Mar. 26, 2015
(86) PCT No.: PCT/FI2015/050207

§ 371 Date: Sep. 27, 2016

(30) Foreign Application Priority Data
Mar. 27, 2014 (FI) 20145286

(51) Int. Cl. D21C 11/00; F16J 15/40; B01D 33/21; F16J 15/00; D21C 9/06; B01D 33/06

(52) U.S. Cl. CPC D21C 11/0078; D21C 11/0085; D21C 9/06; B01D 33/06; B01D 33/21; F16J 15/002; F16J 15/40

(57) ABSTRACT

A method and a liquor filter, in which liquor filter sealing medium is fed via a sealing medium channel (3) into an innermost sealing zone formed by an innermost sealing member (1), an outer seal (2) and the space between them at a causticizing plant of a chemical pulp mill. The sealing medium used is an alkaline sealing liquid and/or gas, which does not substantially dilute the liquor being filtered. Advantageously the sealing medium is filtrate from the liquor filter and/or gas taken from the interior of the liquor filter.

### OBJECT OF THE INVENTION

The present invention relates to liquor filters of a the chemical cycle of a chemical pulp mill, in which filters a feed of a sealing medium into an innermost sealing zone formed between an innermost sealing member, an outer sealing member and the space between them is utilized.

### BACKGROUND OF THE INVENTION

Chemical pulp is produced by cooking wood or annual plants at a high temperature in an alkali-containing solution. In the cooking, cellulose is released and binding agents such as lignin are dissolved in the liquid phase. Chemical pulp is separated from the remaining chemical solution, black liquor, and the black liquor is concentrated by evaporation to a concentration suitable for combustion. In the combustion the organic matter dissolved in the black liquor is burned and the remaining organic chemical smelt can be dissolved into water, weak white liquor or other suitable liquid to form green liquor. This green liquor contains impurities that are insoluble in water, which impurities are usually separated from the liquor before it is used for producing white liquor. White liquor is produced from green liquor by adding burnt lime (CaO) therein. The sodium carbonate contained in the green liquor is causticized to sodium hydroxide needed in chemical pulping. In causticizing the lime converts into lime sludge, fine-grained calcium carbonate, which has to be separated from the white liquor before using the white liquor as cooking chemical or for other purposes.

Thus, cooking chemical of a chemical pulp mill is circulated from cook to cook, with periodical regeneration. Minor chemical losses are compensated by bringing fresh alkaline chemical as a make-up chemical into the circulation. The amount of white liquor needed for producing thousand kilos of chemical pulp used as raw material for paper making is typically 3.5-4 m³ and approximately the same amount of green liquor is needed for producing this white liquor. The amount of chemical pulp produced worldwide is approximately 150 million tons a year. By the order of magnitude of production it is easy to conclude that even a small improvement in the operation of the chemical circulation leads to significant economic advantages.

A chemical pulp mill uses as an active cooking chemical large amounts of white liquor. Green liquor is used mainly for producing white liquor, but in some cases also as such as cooking chemical. Both liquors are also used as such or after further treatment in small amounts e.g. for pH regulation in other process stages within a chemical pulp mill. Nowadays, filtration is most commonly used for separating solids from green or white liquor. Of those, commonly used especially for filtering white liquor are disc filters having a plurality of filtering discs. The liquor filters can be arranged as parallel apparatuses whereby they form a liquor filter group.

Especially in pressurized white and green liquor filters of the chemical pulping industry a pair of seals is typically used, specifically in connection with rotating parts, into a space between said seals clean water is fed, the pressure of which is higher than the pressure prevailing inside the apparatus. The purpose of this sealing water is to prevent the liquor from exiting the interior of the filter outwards. Would the liquor leak from the interior of the apparatus outwards, it would foul and wear the seals of the shaft and cause fouling and corrosion of the apparatus and the environment. When the pressure of the sealing water is higher it can leak inwards into the interior of the filter. The leak can be maintained planned and controlled, whereby the purpose of allowing the leak is to keep the sealing surfaces of the shaft and the seals overall clean. Leaking of sealing water can take place also from the pair of seals outwards as the outermost seals get worn.

When filtering white and green liquor, a purpose is to recover the liquor filtered through the filtering surfaces of the filter at a concentration as high as possible.

Diluting the liquor has the result that it may be inevitable to remove water therefrom before using it in producing chemical pulp, which is always an extra cost. In practice all water that has entered the chemical cycle has to be evaporated in some stage of the circulation. Green liquor contains several inorganic compounds, such as sodium carbonate, sodium sulfide and sodium sulfate. Compounds contained in white liquor mainly comprise sodium hydroxide, sodium sulfide and sodium carbonate. The concentration of white liquor and green liquor can be presented as a TTA (total titratable alkali) value. The TTA-value of white liquor is typically 160-170 g NaOH/I and that of green liquor 160-180 g NaOH/I. It is desirable that these values do not substantially change during the filtration of the liquors.

If leakage of sealing water takes place, it is usually continuous. The diameter of the filter shaft is usually large, over 500 mm. Water leakage should not be allowed, especially with shaft diameters over one meter, because the amount of the leakage is always significant as a whole. The filtered liquor may have to be subjected to a dewatering treatment, such as evaporation, for increasing its concentration in order to ensure an optimal concentration for the process of application.

### BRIEF DESCRIPTION OF THE INVENTION

A novel solution has been developed for avoiding dilution of liquor in a liquor filter at a causticizing plant of a chemical pulp mill. This purpose is achieved such that the method and/or liquor filter defined in the preamble of the independent claims are implemented as defined in the characterizing part of the claims. Preferred embodiments of the invention may correspond to the dependent claims. The present invention allows decreasing the dilution of cooking chemical caused by the sealing liquids of process equipment, and thereby decreasing the need for concentration that consumes energy and evaporation capacity in a later stage of the chemical cycle. Liquor filters of a causticizing plant typically comprise a white liquor filter and a green liquor filter.

Characteristic for the novel method is that alkaline sealing liquid is used in an innermost sealing zone, wherefrom leaking and flushing streams may enter the white or green liquor being filtered. Advantageously this sealing liquid is filtrate of a liquor filter from the same liquor filter or from another liquor filter of the causticizing plant. Also make-up alkali of the causticizing plant, such as a sodium hydroxide solution can serve as sealing liquid or part of it. The sealing liquid used has to be such that it does not substantially dilute the alkali content of the liquor being filtered, such as its TTA-value. In this connection “substantially” means that the alkali content of the liquor being filtered is diluted by at the most 2%, more preferably at the most 1%, most preferably at the most 0-0.5%. Also, the sealing liquid must not essentially change the composition, such as chemical composition of the liquor being filtered.

The invention relates also to a liquor filter comprising at least one filtering member arranged on the shaft of the filter, which shaft is bearing-mounted on the frame of the filter, whereby the shaft is typically sealed with respect to the frame by means of a sealing arrangement. It comprises a sealing sleeve provided with an innermost sealing zone formed by an innermost sealing member and an outer sealing member and a space between them, into which sealing zone a first sealing medium channel is led for feeding sealing medium. The first sealing medium channel for sealing medium is provided with a pressurized flow connection from a filtrate channel of the filter or group of filters in question and/or from another alkali source and/or a source feeding pressurized gas. Additionally, the sealing sleeve is provided with an outermost sealing member, which together with the outer sealing member and a space between them forms an outermost sealing zone, whereto a second sealing medium channel is led for feeding a second sealing medium.

Dilution caused by sealing water is essentially related to the fact that increasing the capacity of the filter has been limited by limiting the liquid level of the basin below the lower surface of the shaft. By raising the level in the basin, a larger part of the area of the filtering discs could be arranged in the basin below the level of the liquor being filtered. Thus, the filtering area of the liquor filter could be increased by up to 50% and the capacity of the filter would grow almost correspondingly. It has not been possible to raise the surface level in the basin over the level of the lower edge of the shaft, because otherwise solids-containing highly abrasive substance, such as lime sludge, would quickly wear the sealing surfaces. Raising the level to above the lower surface of the shaft, e.g. to mid-way of the shaft, would thus increase the leakage of sealing water or the need for drainage to a huge extent. A deep surface level in the basin, e.g. extending to mid-way of the shaft, would also lead to a significant hydrostatic pressure, which would push solids-containing matter into the interior of the sealing surfaces of the seal. Further, the sealing surfaces of an expensive, heavy shaft with a large diameter would wear quickly, which would substantially increase the need for maintenance and repair and the operational costs of the apparatus. Compensating the hydraulic pressure by increasing the pressure of the sealing water and dilution caused by unavoidable leakage, and need for flushing would bring a far too large amount of diluting water into the process. Therefore, in practice liquor filters having a shaft with its lower surface submerged below the level in the basin cannot be used despite the advantage provided by capacity increase. The number of filtering discs could correspondingly be decreased and thus the costs and the size of the apparatus could be decrease, if it was possible to carry out the raising of the level which is essential in view of capacity.

According to the present invention, sealing medium instead of sealing water is introduced into the innermost sealing zone formed of the innermost sealing member, the outer seal and the space between them, which sealing medium does not substantially dilute or detrimentally contaminate the white liquor or green liquor being filtered. Sealing zone refers to both the pair of seals and the space therebetween and the outer seal and a space where the innermost seal is some other arrangement, by means of which the pressure of the sealing medium and the leakage into the interior of the filter is controlled.

Preferably the sealing medium is liquor-containing sealing liquid or gas taken from the interior of the apparatus, leaking of which into the filter does not cause substantial dilution of the liquor being filtered or oxidizing, corrosion or other contamination of the apparatus. In some cases, however, oxidizing of liquor can be advantageous for the process, whereby oxygen-containing gas is advantageous to use as sealing medium gas. Also other clean substances advantageous in view of the process, such as make-up alkali, can be introduced as sealing medium or admix therein. The use of sealing liquid or gas causes the sealing zone to remain clean off impurities wearing the outer seal, whereby the outer seal will last long and leakage outwards is eliminated until the outer seal wears excessively. For instance white liquor can be used as liquor-containing sealing liquid of a green liquor filter and vice versa.

If gas is used as sealing medium, liquor-containing flushing sealing liquid can be added therein. If the lower edge of the liquor filter shaft is below the surface in the basin it is not possible with gas to compensate for the impact of hydrostatic pressure altering in the elevation the way as it is possible when liquid is used. Additionally, gas when leaking into the basin causes intensive bubbling. Then the use of sealing liquid or addition of it into the gas can create a compensating hydrostatic pressure inside the sealing zone in its part that is below the level in the basin. This is essential especially in case of leaking or draining sealing medium, whereby it is not necessary to completely pressurize the sealing medium taking into account the maximum of hydrostatic pressure. The use of liquid sealing medium prevents wearing of sealing surfaces caused by drying and decelerates leaking in tight clearances and therefore it is advantageous to use sealing liquid, if possible even water, admixed to a gaseous sealing medium.

The innermost seal can be arranged to leak, whereby the sealing medium continuously rinses the surfaces of the sealing zone, cleaning them. Instead of a conventional innermost seal e.g. a shaft of a disc filter can then be surrounded with some other sealing member, such as a narrow gap, a sleeve or a labyrinth seal. Also the outermost seal can be leaking if air is used as the gas. External hydrostatic pressure of a submerged shaft can impact the flows of a sealing zone designed as substantially leaking. The most difficult thing is to arrange an adequate flushing flow at the lowermost edge of the sealing member, where reverse flow into the interior of the sealing zone is most prone to be generated. Reverse flow can be prohibited by arranging on the surfaces of the sealing zone flow barriers, such as notches. The surface of the sealing member and/or the seal housing of the sealing zone and/or the shaft can be threaded, whereby the thread continuously and efficiently pumps the sealing medium. The pumping thread can decrease the required feeding pressure. The clearances of the sealing zone or other channeling of the flushing flows can be eccentric, e.g. so that the clearance is larger on the lower surface of the shaft than in the upper surface. The portion of the innermost sealing member that remains dry can also be designed as leak-proof or with an utmost small clearance, whereby leaking is prevented above the shaft. This is especially advantageous if the sealing medium contains gas.

Advantageously the alkaline sealing liquid is obtained from the filtrate channels of the filter or group of filters and pressurized with a pump if needed. Preferably, impurities that wear and foul the sealing surfaces have been filtered off the filtrate. The closer the concentration of the liquor-containing sealing liquid is to the concentration of the liquor being filtered, the less is the extent of harmful dilution. Also liquor obtained from another external source and having a chemical composition that corresponds to that of the liquor being filtered, such as non-used clean liquor even at a higher concentration can be fed as sealing liquid and simultaneously add into the cycle chemicals that are needed in the process. This may allow avoiding the use of a filter that removes impurities from the filtrate in connection with a liquor filter.

The service life of the outer seal can advantageously be prolonged and/or leakage of alkaline sealing liquid out of the apparatus prevented by using at least one outermost pair of seals or a sealing zone wherein sealing water or gas is fed. Sealing water can be fed into this formed pair of seals without causing substantial dilution of the liquor in the filter although the liquor-containing sealing liquid would be slightly diluted due to possible minor water leakage.

The solution according to the invention is especially advantageous in a disc filter, for which periodical thinning and removal of the precoat is effected by moving the shaft of the discs in the longitudinal direction as presented in publication WO2013/117813. Axial movement wears the seals. Further, axial movement leads to easier fouling of the shaft especially at the innermost seal and thus to increased wearing of the sealing surfaces, when the shaft from time to time moves into the interior of the seal. If the lower surface of the shaft were below the level in the basin, passing of solids onto the sealing surfaces would be extremely detrimental and uncontrollable. In order to keep the sealing surfaces clean, it may be inevitable to adjust the leakage of liquor-containing sealing liquid bypassing the innermost seal to be greater than usual and to temporarily increase the pressure and thus the flow during the axial movements. The length of the innermost sealing zone is to be substantially larger than the length of the axial movement in order to keep the shaft clean along the whole sealing surface of the outer seal. An advantageous embodiment is to use a seal housing that is flexible in the longitudinal direction, such as bellows or a telescope structure, whereby the innermost sealing member can stay in place with respect to the longitudinal direction of the shaft.

Due to friction properties and/or keeping the surfaces clean there may be a need to dilute the liquor-containing sealing liquid or to occasionally use water as sealing liquid. Nevertheless, continuous or occasional diluting of the sealing liquid results in a remarkably minor dilution of the filtrate compared to the use of water only as sealing liquid.

### LIST OF DRAWINGS

In the following, examples of the embodiments of the invention are disclosed in more detail with reference to the appended drawings, of which

FIG. 1 illustrates a pair of axial seals, in which sealing medium can be fed at least in between the innermost seal and the outer seal and

FIG. 2 illustrates a filter according to an embodiment of the invention, which is provided with a filter disc shaft arranged movable in the longitudinal direction and a liquid cycle arrangement using liquor as sealing medium.

### DETAILED DESCRIPTION OF THE INVENTION

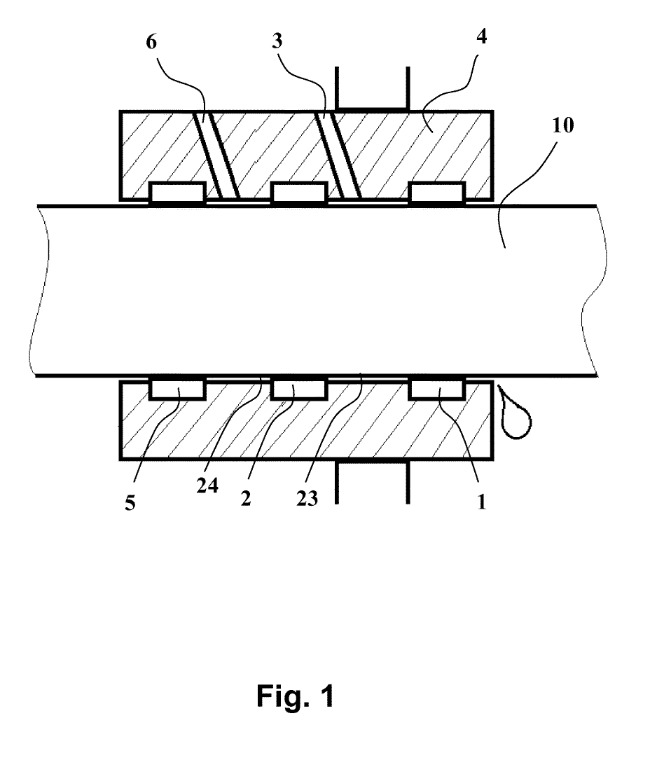

Axial seals 1, 2 according to FIG. 1, which form an innermost pair of seals, are commonly used in the apparatuses of the chemical pulping industry for sealing the shaft with respect to the frame of the apparatus, such as with respect to the basin of the filter. Typically, sealing water has been led in between the seals 1, 2 via a sealing medium channel 3. The innermost seal 1 seals the shaft 10 on the side of the space to be sealed, i.e. on the side of the filter. The outer seal 2 is located outer than the innermost seal 1, on the side of the outer surface. A pressurized sealing medium channel 3 leads through a seal housing (sealing sleeve) 4 into the innermost sealing zone formed by these seals 1, 2 and the space 23 between them. Leakage from between the innermost seal 1 and the shaft 10 is not very detrimental in view of operation of the seal, but it keeps the innermost sealing surfaces clean despite the corrosive and abrasive impact of the substance inside the filter. Since impurities are prevented from getting into the innermost sealing zone due to overpressure, the outer seal 2 keeps clean and does not wear because of impurities. The innermost seal 1 can comprise, in addition to the actual seal, also other typical elements, such as a lip limiting the entry of solid substance onto the actual sealing surfaces.

In the solution according to the invention, the innermost sealing member 1 can advantageously be replaced with another type of sealing member, such as a narrow gap surrounding the shaft, or a longer sleeve or a labyrinth sealing, whereby the sealing medium continuously flows into the filter therethrough and the flow keeps the shaft clean. The smaller the clearance between the innermost seal 1 arranged to leak or the sealing members replacing it and the shaft 10, and the slower the flow, the less sealing medium needs to be pumped to flush the sealing zone. Leaking of liquor-containing sealing medium decreases the capacity of the filter, because the clean or cleaned feed liquor has to be further filtered in the filter. Therefore, its leaking is to be minimized. The surface of the shaft 10, the innermost seal 1, the seal housing (sealing sleeve) 4 and/or other sealing member can advantageously be transversely grooved or threaded for controlling the flush flow and keeping it uniformly adequate. The innermost sealing zone can also be eccentric with respect to the shaft 10 for maintaining a uniformly steady flush flow.

A third outermost seal 5 or another channeling or other arrangement leading the sealing liquid out can be arranged for ensuring that the outwardly leaking liquor-containing sealing liquid from between the outer seal 2 and the shaft 10 cannot cause problems for other components of the filter, such as the bearings of the shaft 10 and their lubrication. This outermost pair of seals or the outermost sealing zone formed by the outermost seal 5 and the outer seal 2 can be pressurized with a sealing medium, preferably water, by leading the medium into the space 24 between them via a second sealing medium channel 6. The outermost pair of seals can be pressurized also e.g. with compressed air or a mixture of compressed air and water. The pressure of the sealing medium of the outermost pair of seals is preferably only slightly higher than the pressure of the liquor-containing sealing liquid. If the pressure of the sealing water would be substantially higher than the pressure of the liquor-containing sealing liquid, leaking of sealing water into the liquor-containing innermost sealing zone could result in the leaking of the same amount of diluting water into the interior of the liquor filter. Since the outer seal 2 operates in cleaner, less abrasive and less corrosive conditions, leaking of sealing water via the innermost sealing zone can in practice be kept insignificant. Flow amounts of leakages, i.e. liquid feeds can be measured for controlling the condition of the seals. The leakage of liquor-containing sealing liquid outwardly can be controlled also by channeling the leakage flow and leading it to a separate vessel or by returning the leaked liquor into the chemical cycle or as sealing liquid. Also then it is advantageous to use the outermost seal 5 or another sealing member for preventing uncontrolled exit of alkaline sealing liquid.

If the aim is to accomplish both channeling the outward leakage and leakage control by means of sealing medium, two outer seals 2 are used, whereby two separate pairs of seals or sealing zones are formed which are sealed with a pressurized sealing medium, from between which outward leakage of liquor-containing sealing liquid and sealing medium of the outer pair of seals is led out. Then the pressure of the sealing medium between the outermost pair of seals need not be higher than the pressure of the liquor-containing sealing liquid of the innermost sealing zone.

The seals 1, 2, 5 of the pairs of seals need not be axial seals, but any connection between two parts that is to be sealed may be used, said connection having an innermost sealing zone formed of an innermost sealing member 1 and on outer seal 2, into which sealing zone a sealing medium is led. Static pairs of seals, however, are not as prone to leakage flows caused by wearing as seals of rotary, and especially longitudinally moving, parts.

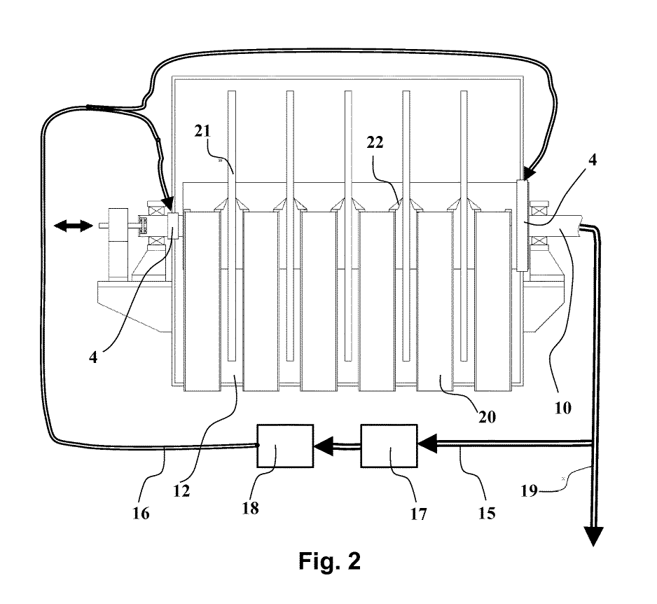

FIG. 2 illustrates as a cross section the main parts of a disc filter. The liquor filter can also be a drum filter. The apparatus shown in the example is provided with a shaft 10 moving in the axial direction and provided with filter discs 21. The discs are partly inside the basin 12, and at least one discharge chute 20 is provided between them. The shaft 10 is bearing-mounted to the frame of the apparatus. Usually the filter is enclosed and sealed as a pressurized vessel for facilitating a pressure difference that intensifies the filtration. The shaft 10 is sealed at its ends by means of seal seats 4 joined to the casing of the filter. In this case the diameters of the sealing zones are of different size at different ends for minimizing leakages by means of a diameter as small as possible. An actuator moving the shaft receives the axial force caused by the diameters of different size. Several filters may be arranged in parallel, whereby they form a group of filters, the filtrate channels 19 of which, led through the shafts 10 can be connected to each other.

White or green liquor suspension to be filtered is fed into the basin 12. Solids are filtered onto the filtering surfaces of the discs and they are scraped off by means of scrapers 22 into discharge chutes 20. The shaft 10 is sealed at its both ends with respect to the frame or the casing of the apparatus by means of the innermost pairs of seals. Sealing medium is fed into the innermost sealing zone. The sealing medium, i.e. in this case sealing liquid is preferably filtrate flown through the filtering surfaces of the filter or group of filters in question. Impurities that wear and foul the sealing surfaces and components of the sealing liquid circulation are preferably filtered off from the sealing liquid. The filtrate can be obtained into the sealing liquid circulation from a filtrate channel 19 connected to the shaft 10 of the filter or group of filters, to which channel 19 a flow connection 15 is joined. Preferably the filtrate is cleaned by leading it via a filter 17. Most preferably the liquor-containing sealing liquid is taken from between the filtrate pump and the filtrate discharge control valve, where the prevailing pressure often is higher than the pressure of the filter.

The pressure of the sealing liquid is to be higher than the internal pressure of the apparatus. If needed, the pressure of the sealing liquid is increased by means of a pump 18. From the pump 18 the filtrate is led via a flow connection 16 into a sealing medium channel 3 of the seal seats 4. If the liquor for the sealing liquid is taken from a source that is pressurized or has a height difference, the pump 18 may be unnecessary. The flow connection 15 for the sealing liquid circulation or the flow connection 16 may be connected to a system feeding pressurized water, for allowing dilution of the sealing liquid or periodical flushing of the components of the sealing liquid circulation and the sealing surfaces of the pair of seals. Pressurized water or compressed air can also be led in between the outer seal 2 and the third seal 5 as sealing medium.

Often it is needed to add sodium chemical into the chemical cycle of a chemical pulp mill for compensating losses. The sodium added to the process can be introduced as a clean liquor solution via the innermost sealing zone of the liquor filter.

If gas is used as a sealing medium, it is preferably taken from inside the apparatus and after a pressure increase by means of a fan, a pump or a compressor it is fed, possibly filtered, into the sealing medium channel 3. A main principal difference compared to FIG. 2 is omitting the filtrate channel connection 19. Then the flow connection 15 is connected to the interior of the apparatus. The use of an external compressed air source does not necessarily lead to a continuous flow inside the sealing zone, and therefore its use is most appropriate when the innermost seal 1 is not arranged to leak or is not worn. Otherwise it is inevitable to let gas out from the interior of the apparatus, which causes odor disturbances.

In case an outer pair of seals formed of the outermost seal 5 and the outer seal 2 is used, sealing water and/or compressed air can be led into the space between them with the corresponding arrangements as have been used in the present apparatuses.

1. A method of feeding a sealing medium into a sealing arrangement of a liquor filter in a causticizing plant of a chemical pulp mill, which arrangement seals a shaft of the filter and which sealing arrangement comprises a sealing sleeve provided with an innermost sealing zone formed by an innermost sealing member and an outer sealing member, a space between them, whereto a first sealing medium channel is led for feeding a sealing medium, wherein the sealing medium utilized is an alkaline liquid, a gas or a mixture thereof, and the alkaline liquid or gas does not substantially dilute the alkali-content of the liquor being filtered and leakage of the alkali-containing sealing liquid and/or gas out of the liquor filter is prevented by an outermost pair of seals formed of an outermost seal and an outer seal.

2. The method according to claim 1, wherein the liquor-containing sealing liquid that is used is filtrate produced by said liquor filter or group of filters in question.

3. The method according to claim 1, wherein the sealing medium in the innermost sealing zone is gas obtained from the interior of the liquor filter.

4. The method according to claim 1, wherein filtrate produced by the liquor filter or group of filters and/or gas taken from inside the liquor filter is cleaned to remove impurities before feeding the filtrate to the innermost sealing zone.

5. The method according to claim 1, wherein water is admixed into the sealing medium or fed instead of the sealing medium.

6. The method according to claim 1, wherein the innermost sealing zone seals the shaft of the filter is moving in the longitudinal direction.

7. The method according to claim 1, wherein a second sealing medium, which is water or gas, is fed into a sealing zone formed of the outermost sealing member and the outer sealing member and a space between them.

8. A liquor filter of a causticizing plant at a chemical pulp mill, wherein the liquor filter comprises:
at least one sealing member arranged on a shaft that is bearing-mounted in a frame of the filter, whereby the shaft is sealed to the frame by a sealing arrangement comprising a sealing sleeve having an innermost sealing zone formed by an innermost sealing member, an outer sealing member and a space between the innermost and outer sealing member, wherein the innermost sealing zone is in fluid communication with a first sealing medium channel,
wherein the first sealing medium channel is configured to connect with a pressurized flow connection from a filtrate channel in fluid communication with the liquor filter or group of liquid filters and/or with a source of an alkali liquid and/or with a source of a pressurized gas and
wherein the sealing sleeve includes an outermost sealing member which together with the outer sealing member define an outermost sealing zone which is in fluid communication with a second sealing medium channel coupled to a source of a second sealing medium.

9. The filter according to claim 8, wherein leaking of liquor-containing sealing liquid out of the liquor filter has been prevented by an outermost pair of seals formed of the outermost seal and the outer seal.

10. The liquor filter according to claim 8, wherein the flow connection leading into the first sealing medium channel comprises a filter removing impurities.

11. The liquor filter according to claim 8, wherein a pressure-increasing pump, fan or compressor is connected to the flow connection leading into the first sealing medium channel.

12. The liquor filter according to claim 8, wherein the innermost sealing zone seals the shaft of the filter, which shaft is arranged movable in the longitudinal direction.

13. The liquor filter according to claim 8, wherein the surface of shaft, the innermost seal, the sealing sleeve and/or another innermost sealing member is notched and/or threaded and/or the innermost sealing zone is eccentric with respect to the shaft.

14. The liquor filter according to claim 8, wherein the lower surface of the shaft is arranged to extend into the basin underneath the level of the liquor being filtered.

15. A method to operate a sealing arrangement of a liquor filter in a causticizing plant of a chemical pulp mill, the method comprising:
rotating a filter member liquor suspension in a basin of the liquor filter;
extracting from the liquor filter a liquid filtrate or a gas;
sealing a gap between a rotating shaft of the liquor and a sleeve or housing supporting the shaft, wherein the sealing is performed using an innermost sealing member positioned in the gap and nearest the basin in the liquor filter, a second sealing member in the gap outward of the basin along the shaft, and an outermost sealing member outward of the second sealing member along the shaft; and
injecting a sealing fluid through a sealing medium channel extending through the sleeve or housing and having an opening to inject the sealing fluid into the gap and between the innermost sealing member and the second sealing member, wherein the sealing fluid includes at least one of the liquid filtrate or gas extracted from the liquor filter.

16. The method of claim 15 wherein the sealing fluid is filtered to remove particles before being injected.

17. The method of claim 15 wherein the sealing fluid is pumped or compressed to a pressure above a pressure in the gap before being injected.

18. The method of claim 15 further comprising injecting the sealing fluid into the gap and between the second sealing member and the outermost sealing member.

19. The method of claim 15 wherein the extraction of the liquid from the liquor filter includes extracting an alkaline liquid.

20. The method of claim 15 wherein the extraction of the liquid from the liquor filter includes extracting an alkaline liquid from the basin.
